(19) United States
(12) Patent Application Publication
(10) Pub. No.: US 2024/0258799 A1
(43) Pub. Date: Aug. 1, 2024

(54) POWER CONVERSION APPARATUS AND METHOD FOR APPLYING SWAP BATTERY

(71) Applicants: Hyundai Motor Company, Seoul (KR); Kia Corporation, Seoul (KR); Foundation for Research and Business, Seoul National University of Science and Technology, Seoul (KR)

(72) Inventors: In-Yong YEO, Bucheon-si (KR); Youn-Sik LEE, Suwon-si (KR); Sang-Jin KIM, Hwaseong-si (KR); Se-Wan CHOI, Seoul (KR); Jae-Hoon KIM, Seoul (KR); Hui-Gyoung SONG, Seoul (KR)

(73) Assignees: Hyundai Motor Company, Seoul (KR); Kia Corporation, Seoul (KR); Foundation for Research and Business, Seoul National University of Science and Technology, Seoul (KR)

(21) Appl. No.: 18/220,938

(22) Filed: Jul. 12, 2023

(30) Foreign Application Priority Data
Feb. 1, 2023 (KR) 10-2023-0013926

(51) Int. Cl. H02J 7/00

(52) U.S. Cl. CPC H02J 7/0013; H02J 7/007; H02J 2207/20

(57) ABSTRACT

A power conversion apparatus capable of simultaneously discharging swap batteries even while reducing the number of power circuits includes a secondary converter configured to convert alternating current (AC) power into direct current (DC) power, a main battery connected to the secondary converter to receive the DC power, a replaceable swap battery block connected to the secondary converter configured for simultaneous discharge with the main battery, a switching circuit configured to turn on or off electrical connection between the replaceable swap battery block and the secondary converter, and a bypass circuit configured to turn on or off electrical connection between the swap battery block and the main battery.

### CROSS-REFERENCE TO RELATED APPLICATION

The present application claims priority to Korean Patent Application No. 10-2023-0013926, filed on Feb. 1, 2023, the entire contents of which is incorporated herein for all purposes by this reference.

### BACKGROUND OF THE PRESENT DISCLOSURE

### Field of the Present Disclosure

The present disclosure relates to a power conversion apparatus for an electric vehicle, and more specifically, to a power conversion apparatus and method for applying a replaceable swap battery.

### Description of Related Art

Cost competitiveness (profitability) is the most important factor for small/light electric vehicles, and the cost reduction of not only high-voltage batteries but also power electric (PE) components is very important. Among the high-voltage PE components, the most expensive component is a high-voltage battery, and a price of the PE component may be reduced only when a capacity of the high-voltage battery is minimized.

However, there are disadvantages in that a travel distance is reduced and outputs of a motor and/or an inverter are reduced. To minimize a price of the high-voltage battery, technology development is being conducted in a direction of reducing a capacity and reducing a voltage, and recently, electric vehicles equipped with a 48 V class system are also being developed.

To minimize a price of the vehicle, low-capacity 48 V main battery electric vehicles are being developed. Furthermore, systems for adding an additional replaceable battery to increase the travel distance and the outputs of the motor and/or the inverter are being developed.

However, in the instant case, a main battery and a swap battery are 48 V class, but have a difference by about 30 to 60 V due to a difference in a state of charge (SOC). When a battery having such a difference in the SOC is connected, there is a risk of fire.

Furthermore, additional power conversion components are required for SOC management and current control of each swap battery and efficient use of the swap battery.

Of course, a method of simultaneously discharging the swap battery has been developed. In the instant case, there is a disadvantage in that the number of power circuit devices increases, and thus the volume and the price increase. Furthermore, there is a problem that an operation is possible only when the voltage of the swap battery is higher than that of the main battery.

Meanwhile, there may also be a method of reducing the volume and the price by minimizing the device. In the instant case, there is a disadvantage in that the swap battery may not be discharged simultaneously.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a power conversion apparatus and method configured for simultaneously discharging swap batteries even while reducing the number of power circuits.

Furthermore, the present disclosure is directed to providing a power conversion apparatus and method configured for optimally operating even when a voltage of a main battery fluctuates.

Furthermore, the present disclosure is directed to providing a power conversion apparatus and method configured for increasing a charging speed of the main battery while simultaneously discharging the swap battery.

To achieve the objects, the present disclosure provides a power conversion apparatus configured for simultaneously discharging swap batteries even while reducing the number of power circuits.

A power conversion apparatus includes a secondary converter configured to convert alternating current (AC) power into direct current (DC) power, a main battery connected to the secondary converter to receive the DC power, a replaceable swap battery block connected to the secondary converter configured for simultaneous discharge with the main battery, a switching circuit configured to turn on or off electrical connection between the replaceable swap battery block and the secondary converter, and a bypass circuit configured to turn on or off electrical connection between the swap battery block and the main battery.

Furthermore, the swap battery block includes a first swap battery block and a second swap battery block parallel to the first swap battery block.

In the instant case, the first swap battery block and the second swap battery block have at least two swap batteries used by being connected in parallel in total.

Furthermore, the switching circuit includes a first switching circuit connected to a front end of the secondary converter and the first swap battery block, and a second switching circuit connected to a rear end of the secondary converter and the second swap battery block.

Furthermore, the power conversion apparatus further includes a controller configured to compare output voltages of at least two swap batteries and an output voltage of the main battery and operate in one of a buck mode, a bypass mode, and a hybrid mode being a combination of the buck mode and the bypass mode according to a result of the comparing.

Furthermore, in the buck mode, when the output voltages of the at least two swap batteries are greater than the output voltage of the main battery, predetermined switching circuits are turned on, a remaining switching circuit is turned off, and the bypass circuits are all turned off.

Furthermore, the buck mode includes a path in which power circulates in the order of the one of the at least two swap batteries, a power semiconductor element positioned at the front end or the rear end of the secondary converter, the main battery, and one of the swap batteries.

Furthermore, the buck mode includes a path in which power circulates in the order of the main battery, one of a power semiconductor element positioned at the front end or the rear end of the secondary converter, and the main battery.

Furthermore, in the hybrid mode, when output voltages of some of the at least two swap batteries are equal to the output voltage of the main battery and output voltages of the remaining one are greater than the output voltage of the main battery, some switching circuits are turned on and the remaining one is turned off, and some bypass circuits are turned on and the remaining one is turned off.

Furthermore, the hybrid mode includes a path in which power circulates in an order of one of the at least two swap batteries, the bypass circuit, the main battery, and the one of the at least two swap batteries.

Furthermore, the hybrid mode includes a path in which power circulates in the order of the remaining one of the at least two swap batteries, a power semiconductor positioned at the front end of the secondary converter, the main battery, and the remaining one of the swap batteries.

Furthermore, the hybrid mode includes a path in which power circulates in the order of the main battery, one of power semiconductor elements positioned at the front end of the secondary converter, and the main battery.

Furthermore, in the bypass mode, when the output voltages of all of the at least two swap batteries are equal to the output voltage of the main battery, the switching circuits are all turned off, and the bypass circuits are all turned on.

Furthermore, the bypass mode includes a path in which power circulates in an order of all of the at least two swap batteries, the bypass circuit, the main battery, and all of the at least two swap batteries.

Furthermore, each of the first swap battery block and the second swap battery block have at least two swap batteries, and the at least two swap batteries are used by being connected in parallel when their states of charge are the same.

Furthermore, the secondary converter operates as a dual active bridge (DAB) converter or a dual-bridge series resonant converter (DBSRC) together with a primary converter and a transformer disposed between the primary converter and the secondary converter upon charging operation of a charger.

Furthermore, the bypass circuit includes a switching element configured to turn on or off electrical connection between the swap battery block and the main battery, and

a forward element configured to allow DC power to flow from the swap battery block to the main battery in a forward direction thereof.

Meanwhile, another exemplary embodiment of the present disclosure provides a power conversion method for applying a swap battery including checking, by a controller, whether operation selection of charge using a replaceable swap battery block connected to a secondary converter is performed, turning on or off, by the controller, electrical connection between the replaceable swap battery block and the secondary converter using a switching circuit to supply DC power to a main battery, and turning on or off, by the controller, electrical connection between the swap battery block and the main battery using a bypass circuit.

In the instant case, the checking includes comparing, by the controller, output voltages of at least two swap batteries with an output voltage of the main battery, and operating, by the controller, in one of a buck mode, a bypass mode, and a hybrid mode that combines the buck mode and the bypass mode according to a result of the comparing.

Furthermore, the checking includes supplying DC power to the main battery using a charger including a primary converter when there is no operation selection of charging using the swap battery block.

According to an exemplary embodiment of the present disclosure, when the swap battery is used, it is possible to utilize the swap battery by adding an additional buck converter.

Furthermore, as another effect of the present disclosure, it is possible to increase the travel distance of the electric vehicle and/or improve the power performance of the vehicle.

Furthermore, as yet another effect of the present disclosure, it is possible to minimize the capacity of the buck converter and design the high-capacity bypass circuit, minimizing the cost increase.

Furthermore, as yet another effect of the present disclosure, it is possible to implement the simultaneous discharging function of the swap battery, increasing the charging speed of the main battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a configuration block diagram of a power conversion apparatus for applying a swap battery according to an exemplary embodiment of the present disclosure.

FIG. 2 is an example of a circuit diagram according to FIG. 1.

FIG. 3 is a conceptual diagram upon operation of a charger according to an exemplary embodiment of the present disclosure.

FIG. 4 is a circuit diagram showing a general operating principle of the charger.

FIG. 5 is a waveform diagram according to an operation of FIG. 4.

FIG. 6A and FIG. 6B are conceptual diagrams showing that some swap batteries operate in a buck mode upon swap battery direct current (SBDC) operation according to an exemplary embodiment of the present disclosure.

FIG. 7A and FIG. 7B are conceptual diagrams showing that some swap batteries operate in a bypass mode and the remaining one swap battery operates in the buck mode upon SBDC operation according to an exemplary embodiment of the present disclosure.

FIG. 8 is a conceptual diagram showing that all swap batteries operate in the bypass mode upon SBDC operation according to an exemplary embodiment of the present disclosure.

FIG. 9 is a flowchart showing a power conversion process for applying a swap battery according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The above-described objects, features, and advantages will be described below in detail with reference to the accompanying drawings, and thus those skilled in the art to which the present disclosure pertains will be able to easily implement the technical spirit of the present disclosure. In describing the present disclosure, when it is determined that the detailed description of the known technology related to the present disclosure may unnecessarily obscure the gist of the present disclosure, a detailed description thereof will be omitted.

Hereinafter, exemplary embodiments of the present disclosure will be described in detail with reference to the accompanying drawings. In the drawings, the same reference numerals are used to indicate the same or similar components.

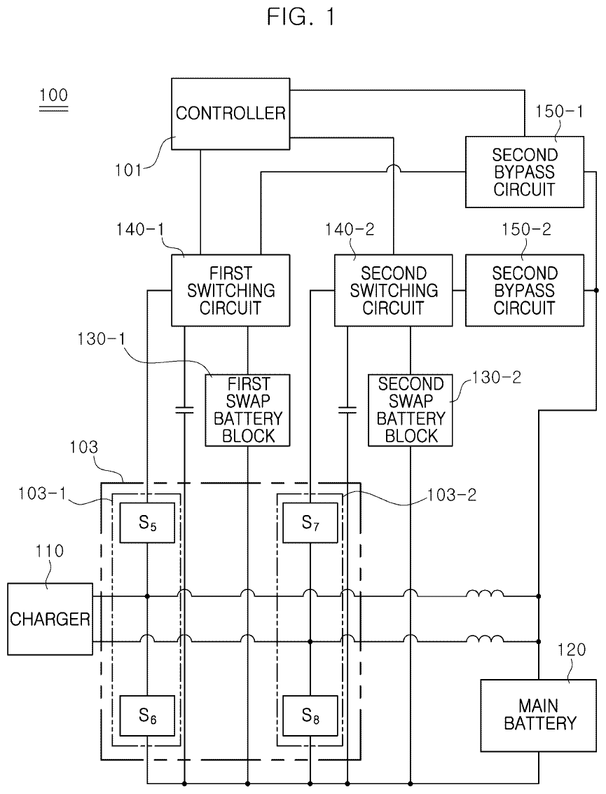

FIG. 1 is a configuration block diagram of a power conversion apparatus 100 for applying a swap battery according to an exemplary embodiment of the present disclosure. Referring to FIG. 1, the power conversion apparatus 100 may include a controller 101, a charger 110, a secondary converter 103, a main battery 120, swap battery blocks 130-1 and 130-2, switching circuits 140-1 and 140-2, bypass circuits 150-1 and 150-2, etc.

The controller 101 is connected to the components and is configured to transmit and receive signals. Of course, some components may perform ON/OFF control without receiving the signals. Furthermore, the controller 101 executes an algorithm for operating the swap battery blocks 130-1 and 130-2 in a buck mode or a bypass mode. To the present end, the controller 101 may include a microprocessor, a memory, an electronic device, etc.

The secondary converter 103 is configured to convert alternating-current (AC) power output from the charger 110 into direct-current (DC) power. To the present end, the secondary converter 103 includes a front end 103-1 and a rear end 103-2. Power semiconductor elements S₅, S₆, S₇, and S₅ are configured at the front end 103-1 and the rear end 103-2. In other words, two power semiconductor elements S₅ and S₆ connected in series are configured at the front end 103-1, and two power semiconductor elements S₇ and S₈ connected in series are also configured at the rear end 103-2.

As the power semiconductor elements S₅, S₆, S₇, and S₈, a field effect transistor (FET), metal oxide semiconductor FET (MOSFET), an insulated gate bipolar mode transistor (IGBT), a power rectifier diode, a thyristor, a gate turn-off (GTO) thyristor, a triode for alternating current (TRIAC), a silicon controlled rectifier (SCR), an integrated circuit (IC) circuit, etc. may be used.

A bipolar, power metal oxide silicon field effect transistor (MOSFET) device, etc. may be used. The power MOSFET device includes a double-diffused metal oxide semiconductor (DMOS) structure unlike general MOSFETs due to a high-voltage and high-current operation.

The charger 110 is an onboard charger. The charger 110 is configured to convert AC into DC and charge a battery in a vehicle.

The main battery 120 may have battery cells configured in series and/or in parallel. Of course, the main battery 120 may be formed of a battery module in which the battery cells are arranged.

The battery cell may be a high-voltage battery for an electric vehicle, such as a nickel metal battery, a lithium ion battery, a lithium polymer battery, a lithium sulfur, a flow battery, or an all-solid-state battery. In general, the high-voltage battery is a battery used as a power source for moving the electric vehicles and refers to a high voltage of 100 V or higher. However, the present disclosure is not limited thereto, and a low-voltage battery is also possible.

Furthermore, the main battery 120 may include a battery management system (BMS). The BMS is configured to optimize battery management for eco-friendly vehicles to increase energy efficiency and extend a lifespan. The BMS monitors a voltage, a current, and a temperature of the battery in real time and prevents excessive charging and discharging, improving the safety and reliability of the battery. The BMS generates battery state information. The battery state information may generally include a state of charge (SOC), but include a state of health (SOH), a depth of discharging (DOD), a state of function (SOF), etc.

The swap battery blocks 130-1 and 130-2 may include one or more replaceable swap batteries.

The first swap battery block 130-1 and the second swap battery block 130-2 are configured in parallel. Similar to the main battery, the swap battery may also have battery cells configured in series and/or in parallel. Furthermore, the swap battery may also include the BMS.

The switching circuits 140-1 and 140-2 are connected to the secondary converter 103 and the swap battery blocks 130-1 and 130-2 to turn the swap battery blocks 130-1 and 130-2 in the buck mode and/or the bypass mode. To the present end, the first switching circuit 140-1 is connected to the front end 103-1 of the secondary converter 103 and the first swap battery block 130-1, and the second switching circuit 140-2 is connected to the rear end 103-2 of the secondary converter 103 and the second swap battery block 130-2.

The bypass circuits 150-1 and 150-2 perform a function of the bypass mode that allows power (i.e., DC power) to flow from the swap battery blocks 130-1 and 130-2 to the main battery 120. In other words, by bypassing the buck mode, the power (i.e., DC power) directly flows from the swap battery blocks 130-1 and 130-2 to the main battery 120.

The first bypass circuit 150-1 is disposed in series between the first switch circuit 140-1 and the main battery 120, and the second bypass circuit 150-2 is disposed in series between the second switch circuit 140-2 and the main battery 120.

Furthermore, the bypass circuits 150-1 and 150-2 prevent power from flowing from the main battery 120 toward the swap battery blocks 130-1 and 130-2 in a reverse direction thereof.

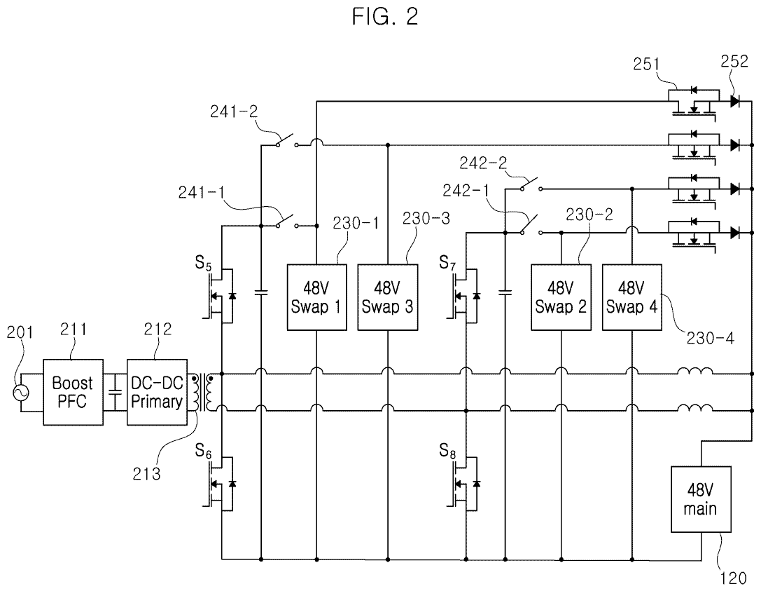

FIG. 2 is an example of a circuit diagram according to FIG. 1. Referring to FIG. 2, the charger 110 may include an input filter for removing noise of an AC power source 201, which is an input power source, a power factor corrector (PFC) circuit 211 for boosting energy efficiency, a primary converter 212 for performing bridge switching, a transformer 213 for stepping-up or stepping-down the AC power, etc.

The primary converter 212 is an isolated DC-DC converter. The primary converter 212, the transformer 213, and the secondary converter 103 are components of a dual active bridge (DAB) converter. In other words, the primary converter 212 is a primary bridge switching circuit, and the secondary converter 103 is a secondary bridge switching circuit.

The first swap battery block 130-1 may include a first swap battery 230-1 and a third swap battery 230-3 configured in parallel, and the second swap battery block 130-2 may include a second swap battery 230-2 and a fourth swap battery 230-4 configured in parallel. Of course, one swap battery may also be configured in each of the first and second swap battery blocks 130-1 and 130-2, and two or more swap batteries may also be configured. Alternatively, three or more swap battery blocks may also be configured.

Furthermore, the first swap battery 230-1 and the third swap battery 230-3 are configured in the first swap battery block 130-1, and the second swap battery 230-2 and the fourth swap battery 230-4 are configured in the second swap battery block 130-2, but the present disclosure is not limited thereto.

Furthermore, the first swap battery 230-1 and the second swap battery 230-2 are configured in parallel in the first swap battery block 130-1, and the third swap battery 230-3 and the fourth swap battery 230-4 may also be configured in parallel in the second swap battery block 130-2.

As the first to fourth swap batteries 230-1 to 230-4, a battery having a nominal voltage of about 48 V is used, but the present disclosure is not limited thereto, and batteries having other voltages may also be used.

Of course, as the main battery 120, the battery having the nominal voltage of about 48 V is also used, but the present disclosure is not limited thereto, and batteries having other voltages may also be used.

The first switching circuit 140-1 includes a 1-1 relay switch 241-1 and a 1-2 relay switch 241-2. The 1-1 relay switch 241-1 has one end connected to the first swap battery 230-1 and the other end connected to the front end 103-1 of the secondary converter 103. Similarly, the 1-2 relay switch 241-2 also has one end connected to the third swap battery 230-3 and the other end connected to the front end 103-1 of the secondary converter 103.

Furthermore, the second switching circuit 140-2 also includes a 2-1 relay switch 242-1 and a 2-2 relay switch 242-2. The 2-1 relay switch 242-1 has one end connected to the second swap battery 230-2 and the other end connected to the rear end 103-2 of the secondary converter 103. Similarly, the 2-2 relay switch 242-2 also has one end connected to the fourth swap battery 230-4 and the other end connected to the rear end 103-2 of the secondary converter 103.

The first and second bypass circuits 150-1 and 150-2 include a switching element 251 and a forward element 252. Of course, the first and second bypass circuits 150-1 and 150-2 may also include only the switching element 251. The switching element 251 is configured to turn on or off the electrical connection between the swap batteries 230-1 to 230-4 and the main battery 120.

The switching element 251 and the forward element 252 are connected in series. A power relay is used as the switching element 251, but the present disclosure is not limited thereto, and semiconductor switching elements, such as a FET, a MOSFET, an IGBT, and a power rectifying diode, a thyristor, a GTO thyristor, a TRIAC, an SCR, an IC circuit, etc. may be used.

As the forward element 252, a positive diode, etc. may be used. In other words, it is possible to prevent power from flowing in the reverse direction thereof. Therefore, power flows only toward the main battery 120 from the swap batteries 230-1 to 230-4.

Meanwhile, in FIG. 2, the FETs are used as the power semiconductor elements S₅, S₆, S₇, and S₈, but the present disclosure is not limited thereto.

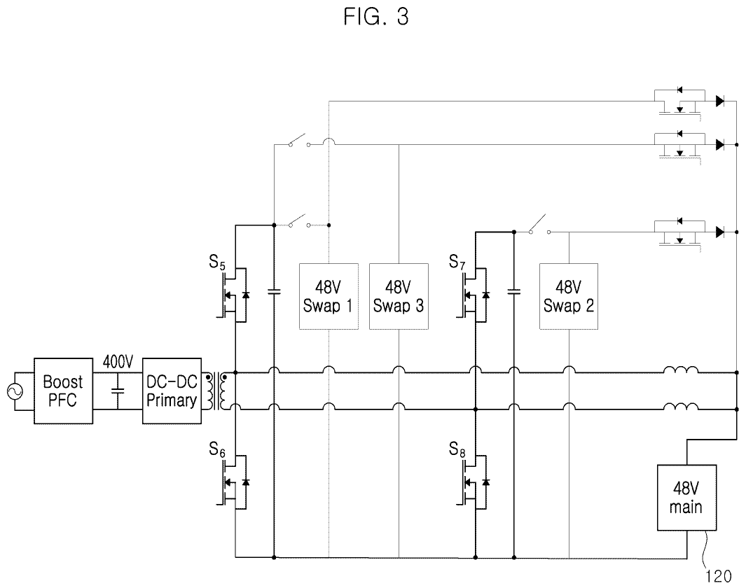

FIG. 3 is a conceptual diagram upon operation of a charger according to an exemplary embodiment of the present disclosure. FIG. 3 is a conceptual diagram of an operation in a case in which three swap batteries are used in a state in which the fourth swap battery 230-4 is removed from the circuit diagram of FIG. 2. Referring to FIG. 3, when the charger 110 operates, all relay switches 241-1, 241-2, and 242-1 are turned off, and all bypass circuits are also turned off. In the instant case, neither the buck mode nor the bypass mode is applied, and the main battery 120 is charged through the charger 110 and the secondary converter 103.

Referring to FIG. 3, when the charger operates, it becomes equivalently current-fed DAB. Furthermore, the primary converter, as an insulator, is configured to perform an optimal insulation operation even when the voltage of the main battery fluctuates. In other words, it is possible to minimize a circulating current and perform zero voltage switching (ZVS) in a wide voltage range. Of course, not only a DAB converter but also a dual-bridge series resonant converter (DBSRC) may be applied thereto.

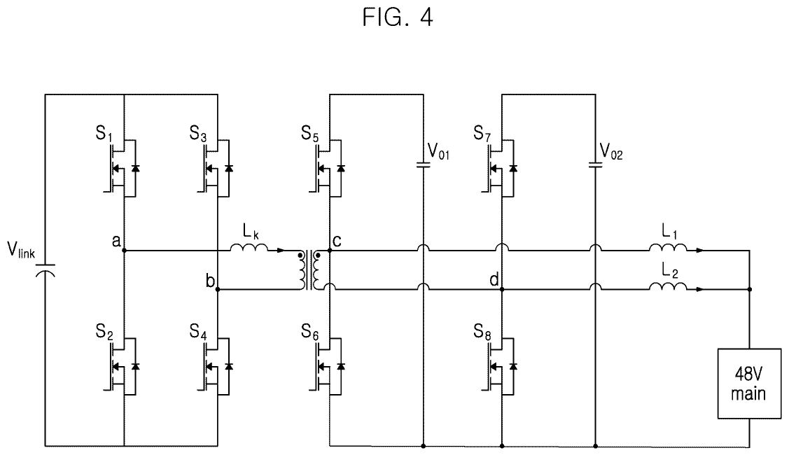

FIG. 4 is a circuit diagram showing a general operating principle of the charger 110. In other words, FIG. 4 shows the operating principle of the DAB converter including the primary converter 212, the transformer 213, and the secondary converter 103.

Referring to FIG. 4, the first to fourth power semiconductor elements S₁, S₂, S₃, and S₄ are configured in the primary converter 212, and the fifth to eighth power semiconductor elements S₅, S₆, S₇, and S₅ are configured in the secondary converter 103. The transformer 213 is disposed between the primary converter 212 and the secondary converter 103.

An input terminal of the transformer 213 is connected to neutral points a and b of the primary converter 212, and similarly, an output terminal of the transformer 213 is also connected to neutral points c and d of the secondary converter 103. Inductors L₁ and L₂ are respectively connected to the neutral points c and d, and the inductors L₁ and L₂ are connected to the main battery 120. Furthermore, an inductor Lₖ is configured at the input terminal of the transformer 213, and thus an amount of current is increased.

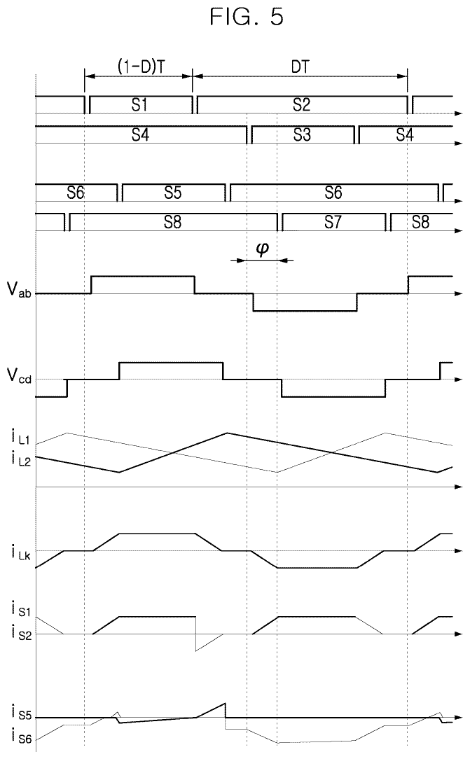

Furthermore, a capacitor is configured in the secondary converter 103 to generate capacitor voltages V₀₁ and V₀₂. When a link voltage Vₗᵢₙₖ is input to the primary converter 212, a waveform diagram as shown in FIG. 5 is generated.

Referring to FIGS. 4, S₂ and S₄, and S₆ and S₈ include a 180° phase shift. In other words, the power semiconductor element S₂ and the power semiconductor element S₄ include a 180° phase shift (ϕ), and the power semiconductor element S₆ and the power semiconductor element S₈ also include a 180° phase shift.

FIG. 5 is a waveform diagram according to an operation of FIG. 4. Referring to FIG. 5, D corresponds to S₂, S₄, S₆, and S₈, and 1-D corresponds to S₁, S₃, S₅, and S₇. T is a period, V_{ab} is a voltage between a and b, V_{cd} is a voltage between c and d, i_{L1} is a current flowing through L₁, i_{L2} is a current flowing through L₂, i_{LK} is a current flowing through Lₖ, i_{S1} is a current flowing through S₁, iₛ₂ is a current flowing through S₂, iₛ₅ is a current flowing through S₅, and i_{S6} is a current flowing through S₆.

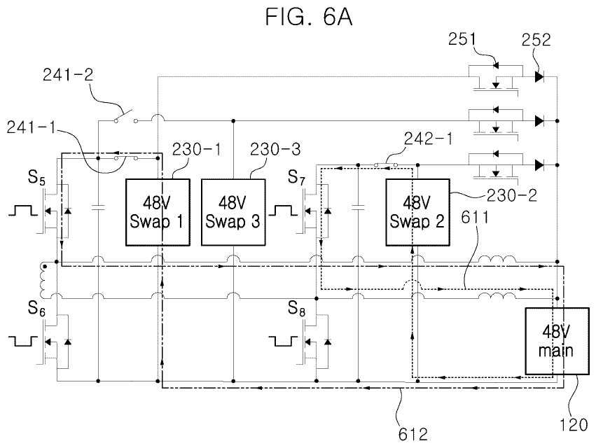

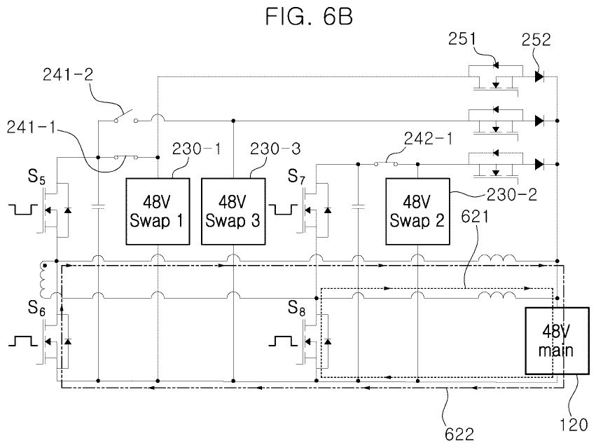

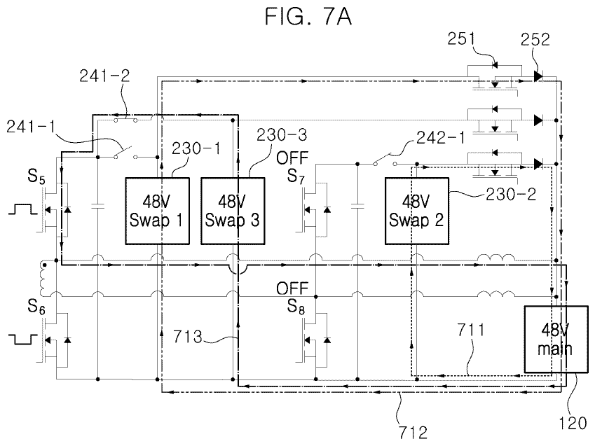

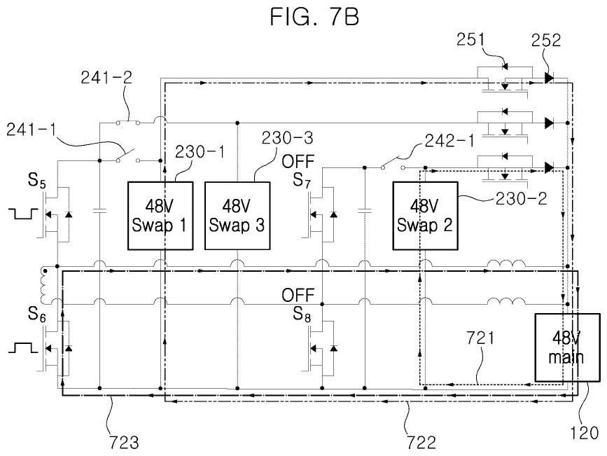

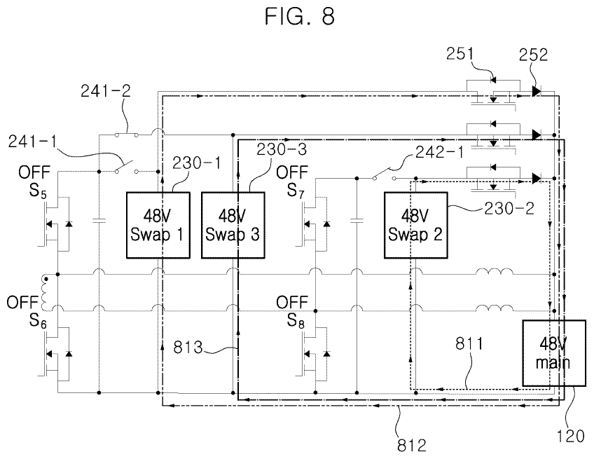

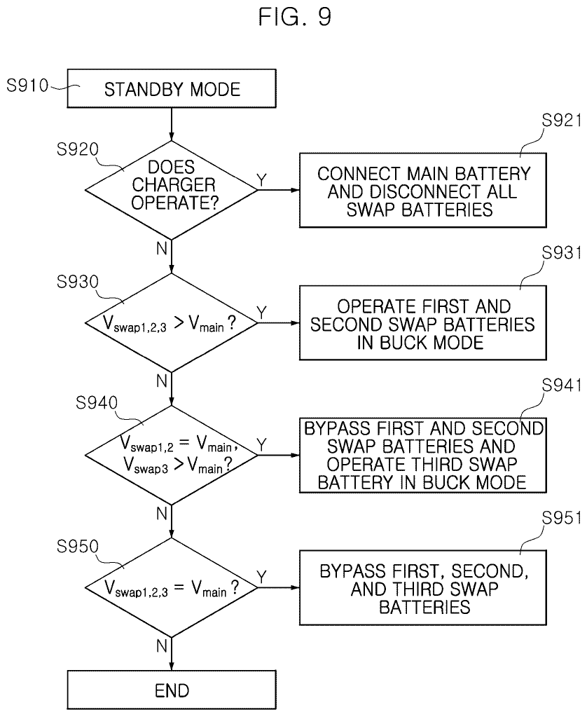

FIG. 6A and FIG. 6B, FIG. 7A and FIG. 7B, FIG. 8, and FIG. 9 are operation conceptual diagrams in a case in which three swap batteries 230-1 to 230-3 are used in a state in which the fourth swap battery 230-4 is removed from the circuit diagram of FIG. 2.

FIG. 6A and FIG. 6B are conceptual diagrams showing that some swap batteries operate in a buck mode upon swap battery direct current (SBDC) operation according to an exemplary embodiment of the present disclosure. The buck mode is a mode in which the input voltage steps down and is output.

Referring to FIG. 6A and FIG. 6B, when output voltages V_{swap1,2,3} of the swap batteries 230-1 to 230-4 are greater than an output voltage Vₘₐᵢₙ of the main battery 120, the 1-1 and 2-1 relay switches 241-1 and 242-1 are turned on, and the 1-2 relay switch 241-2 is turned off. Furthermore, all bypass circuits 150-1 and 150-2 are turned off. Furthermore, pulse width modulation (PWM) control is performed on the power semiconductor elements S₅, S₆, S₇, and S₈.

Therefore, the buck mode shown in FIG. 6A and FIG. 6B is generated. As shown in FIG. 6A, a 1-1 path 612 in which power circulates in the order of the first swap battery 230-1→the power semiconductor element S₅→the main battery 120→the first swap battery 230-1 is generated.

Furthermore, as shown in FIG. 6A, a 1-2 path 611 in which power circulates in the order of the second swap battery 230-2→the power semiconductor element S₇→the main battery 120→the second swap battery 230-2 is generated.

Furthermore, as shown in FIG. 6B, a 1-1 path 622 in which power circulates in the order of the first swap battery 230-1→the power semiconductor element S₅→the main battery 120→the first swap battery 230-1 is generated.

Furthermore, as shown in FIG. 6B, a 2-2 path 621 in which power circulates in the order of the main battery 120→the power semiconductor element S₈→the main battery 120 is generated.

As shown in FIG. 6A and FIG. 6B, the two first and second swap batteries 230-1 and 230-2 operate in the buck mode, and the third swap battery 230-3 in an OFF state is not used.

FIG. 7A and FIG. 7B are conceptual diagrams showing that some swap batteries operate in the bypass mode and the remaining one swap battery operates in the buck mode upon SBDC operation according to an exemplary embodiment of the present disclosure.

Referring to FIG. 7A and FIG. 7B, when the output voltages Vswap1,2 of the first and second swap batteries 230-1 and 230-2 are equal to the output voltage Vₘₐᵢₙ of the main battery 120, and the output voltage Vswap3 of the third swap battery 230-3 is greater than the output voltage Vₘₐᵢₙ of main battery 120, the 1-1 and 2-1 relay switches 241-1 and 242-1 are turned off, and the 1-2 relay switch 241-2 is turned on.

Furthermore, the bypass circuits 150-1 and 150-2 connected to the first and second swap batteries 230-1 and 230-2 are turned on, and the bypass circuit connected to the third swap battery 230-3 is turned off. Furthermore, PWM control is performed on the power semiconductor elements S₅ and S₆, and the power semiconductor elements S₇ and S₈ are turned off.

Therefore, a hybrid mode shown in FIG. 7A and FIG. 7B is generated. In other words, the hybrid mode is a combination of the buck mode and the bypass mode. In other words, some of the swap batteries 230-1 to 230-3 operate in the buck mode, and the remainder operates in the bypass mode.

As shown in FIG. 7A, a 1-1 path 711 in which power circulates in the order of the second swap battery 230-2→the bypass circuits 150-1 and 150-2→the main battery 120→the second swap battery 230-2 is generated.

Furthermore, as shown in FIG. 7A, a 1-2 path 712 in which power circulates in the order of the first swap battery 230-1→the bypass circuits 150-1 and 150-2→the main battery 120→the first swap battery 230-1 is generated.

Furthermore, as shown in FIG. 7A, a 1-3 path 713 in which power circulates in the order of the third swap battery 230-3→the power semiconductor element S₅→the main battery 120→the third swap battery 230-3 is generated.

Furthermore, as shown in FIG. 7B, a 2-1 path 721 in which power circulates in the order of the second swap battery 230-2→the bypass circuits 150-1 and 150-2→the main battery 120→the second swap battery 230-2 is generated.

Furthermore, as shown in FIG. 7B, a 2-2 path 722 in which power circulates in the order of the first swap battery 230-1→the bypass circuits 150-1 and 150-2→the main battery 120→the first swap battery 230-1 is generated.

Furthermore, as shown in FIG. 7B, a 2-3 path 723 in which power circulates in the order of the main battery 120→the power semiconductor element S₆→the main battery 120 is generated.

FIG. 8 is a conceptual diagram showing that all swap batteries operate in the bypass mode upon SBDC operation according to an exemplary embodiment of the present disclosure. FIG. 8 shows a case in which the output voltages V_{swap1,2,3} of all the swap batteries 230-1, 230-2, and 230-3 are the same as the output voltage V main of the main battery 120.

In the instant case, by bypassing the secondary converter 103, power directly flows from the swap batteries 230-1, 230-2, and 230-3 to the main battery 120. To the present end, all relay switches 241-1, 241-2, and 242-1 are turned off, and all bypass circuits 150-1 and 150-2 are turned on. Furthermore, the power semiconductor elements S₅, S₆, S₇, and S₅ are all turned off to turn off the secondary converter 103.

As shown in FIG. 8, a 1-1 path 811 in which power circulates in the order of the second swap battery 230-2→the bypass circuits 150-1 and 150-2→the main battery 120→the second swap battery 230-2 is generated.

Furthermore, a 1-2 path 812 in which power circulates in the order of the first swap battery 230-1→the bypass circuits 150-1 and 150-2→the main battery 120→the first swap battery 230-1 is generated.

Furthermore, a 1-3 path 813 in which power circulates in the order of the third swap battery 230-3→the bypass circuits 150-1 and 150-2→the main battery 120→the third swap battery 230-3 is generated.

FIG. 9 is a flowchart showing a power conversion process for applying a swap battery according to an exemplary embodiment of the present disclosure. Referring to FIG. 9, after a vehicle is in a standby mode, the controller 101 checks whether there is an operation selection of the charger for charging (steps S910 and S920).

In step S920, as a result of the check, when there is a selection for the operation of the charger 110, the controller 101 connects the charger 110 to the main battery 120 and disconnects all swap batteries (step S921).

In contrast, in step S920, when there is no selection for the operation of the charger 110 as a result of the check, the controller 101 compares the output voltages V_{swap1,2,3} of the swap batteries 230-1 to 230-3 with the output voltage Vₘₐᵢₙ of the main battery 120 (step S930).

In step S930, as a result of the comparing, when the output voltages V_{swap1,2,3} of the swap batteries 230-1 to 230-3 are greater than the output voltage Vₘₐᵢₙ of the main battery 120, the first and second swap batteries 230-1 and 230-2 operate in the buck mode (step S931).

In contrast, in step S930, as a result of comparison, when the output voltages V_{swap1,2,3} of the swap batteries 230-1 to 230-3 are not greater than the output voltage V main of the main battery 120, some output voltages V_{swap1,2} are equal to the output voltage V main of the main battery 120, and the remaining output voltage V_{swap3} is compared to the output voltage V main of the main battery 120 (step S940).

In step S940, when some output voltages V_{swap1,2} are equal to the output voltage Vₘₐᵢₙ of the main battery 120 and the remaining output voltage V_{swap3} is greater than the output voltage Vₘₐᵢₙ of the main battery 120, the hybrid mode is operated (step S941). In other words, the first and second swap batteries 230-1 and 230-2 operate in the bypass mode, and the third swap battery 230-3 operates in the buck mode.

In contrast, in step S940, as a result of the comparing, when some output voltages V_{swap1,2} is not equal to the output voltage Vₘₐᵢₙ of the main battery 120, and the remaining output voltages V_{swap3} is not greater than the output voltage Vₘₐᵢₙ of the main battery 120, whether the output voltages V_{swap1,2,3} of the swap batteries 230-1 to 230-3 are equal to the output voltage Vₘₐᵢₙ of the main battery 120 is checked (step S950).

As a result of the check in operation S950, when the output voltages V_{swap1,2,3} of the swap batteries 230-1 to 230-3 are equal to the output voltage Vₘₐᵢₙ of the main battery 120, all the swap batteries 230-1 to 230-3 operate in the bypass mode (step S951).

In contrast, as a result of the check in step S950, when the output voltages V_{swap1,2,3} of the swap batteries 230-1 to 230-3 are not equal to the output voltage Vₘₐᵢₙ of the main battery 120, the process is finished.

Meanwhile, it is also possible to use the SOC. In other words, when the controller 101 checks the SOCs of the swap batteries 230-1 to 230-3 and the SOCs of the first and second swap batteries 230-1 and 230-2 are the same, the first and second swap batteries 230-1 and 230-2 may be used by being connected in parallel. In the instant case, the relay switches 241-1 and 241-2 are turned on.

Furthermore, the operations of the method or the algorithm described in connection with the exemplary embodiments included herein are implemented in a form of program instructions which may be executed through various computer means, such as a microprocessor, a processor, a central processing unit (CPU), and recorded on a computer readable medium. The computer readable medium may include program (instruction) codes, data files, data structures, etc. Alone or in combination.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A power conversion apparatus for applying a swap battery, the apparatus comprising:
a secondary converter configured to convert alternating current (AC) power into direct current (DC) power;
a main battery connected to the secondary converter to receive the DC power;
a replaceable swap battery block connected to the secondary converter configured for simultaneous discharge with the main battery;
a switching circuit configured to turn on or off electrical connection between the replaceable swap battery block and the secondary converter; and
a bypass circuit configured to turn on or off electrical connection between the swap battery block and the main battery.

2. The power conversion apparatus of claim 1, wherein the swap battery block includes:
a first swap battery block; and
a second swap battery block parallel to the first swap battery block, wherein the first swap battery block and the second swap battery block include at least two swap batteries used by being connected in parallel in total.

3. The power conversion apparatus of claim 2, wherein the switching circuit includes:
a first switching circuit connected to a front end of the secondary converter and the first swap battery block, and
a second switching circuit connected to a rear end of the secondary converter and the second swap battery block.

4. The power conversion apparatus of claim 2, further including a controller configured to compare output voltages of the at least two swap batteries and an output voltage of the main battery and to operate in one of a buck mode, a bypass mode, and a hybrid mode being a combination of the buck mode and the bypass mode according to a result of the comparing.

5. The power conversion apparatus of claim 4, wherein in the buck mode,
when the output voltages of the at least two swap batteries are greater than the output voltage of the main battery, predetermined switching circuits are turned on, a remaining switching circuit is turned off, and the bypass circuits are all turned off.

6. The power conversion apparatus of claim 5, wherein the buck mode includes a path in which power circulates in an order of one of the at least two swap batteries, a power semiconductor element positioned at the front end or the rear end of the secondary converter, the main battery, and the one of the at least two swap batteries.

7. The power conversion apparatus of claim 5, wherein the buck mode includes a path in which power circulates in an order of the main battery, one of a power semiconductor element positioned at the front end or the rear end of the secondary converter, and the main battery.

8. The power conversion apparatus of claim 4, wherein in the hybrid mode, when output voltage of at least one of the at least two swap batteries is equal to the output voltage of the main battery and output voltage of a remaining one of the at least two swap batteries is greater than the output voltage of the main battery, predetermined switching circuits are turned on and a remaining switching circuit is turned off, and predetermined bypass circuits are turned on and a remaining bypass circuit is turned off.

9. The power conversion apparatus of claim 8, wherein the hybrid mode includes a path in which power circulates in an order of the at least one of the at least two swap batteries, the predetermined bypass circuits, the main battery, and the at least one of the at least two swap batteries.

10. The power conversion apparatus of claim 9, wherein the hybrid mode includes a path in which power circulates in an order of the remaining one of the at least two swap batteries, a power semiconductor positioned at the front end of the secondary converter, the main battery, and the remaining one of the at least swap batteries.

11. The power conversion apparatus of claim 9, wherein the hybrid mode includes a path in which power circulates in an order of the main battery, one of power semiconductor elements positioned at the front end of the secondary converter, and the main battery.

12. The power conversion apparatus of claim 4, wherein in the bypass mode, when the output voltages of all of the at least two swap batteries are equal to the output voltage of the main battery, the switching circuit is turned off, and the bypass circuit is turned on.

13. The power conversion apparatus of claim 12, wherein the bypass mode includes a path in which power circulates in an order of all of the at least two swap batteries, the bypass circuit, the main battery, and all of the at least two swap batteries.

14. The power conversion apparatus of claim 2, wherein each of the first swap battery block and the second swap battery block includes at least two swap batteries, and the at least two swap batteries are used by being connected in parallel when states of charge thereof are a same.

15. The power conversion apparatus of claim 1, wherein the secondary converter operates as a dual active bridge (DAB) converter or a dual-bridge series resonant converter (DBSRC) together with a primary converter and a transformer disposed between the primary converter and the secondary converter upon charging operation of a charger.

16. The power conversion apparatus of claim 1, wherein the bypass circuit includes:
a switching element configured to turn on or off electrical connection between the swap battery block and the main battery, and
a forward element configured to allow DC power to flow from the swap battery block to the main battery in a forward direction thereof.

17. A power conversion method for applying a swap battery, the method comprising:
checking, by a controller, whether operation selection of charge using a replaceable swap battery block connected to a secondary converter is performed;
turning on or off, by the controller, electrical connection between the replaceable swap battery block and the secondary converter using a switching circuit to supply DC power to a main battery; and
turning on or off, by the controller, electrical connection between the swap battery block and the main battery using a bypass circuit.

18. The power conversion method of claim 17, wherein the checking includes:
comparing, by the controller, output voltages of at least two swap batteries with an output voltage of the main battery, and
operating, by the controller, in one of a buck mode, a bypass mode, and a hybrid mode that combines the buck mode and the bypass mode according to a result of the comparing.

19. The power conversion method of claim 17, wherein the checking includes supplying DC power to the main battery using a charger including a primary converter when there is no operation selection of charging using the swap battery block.
